(19) United States
(12) Patent Application Publication
(10) Pub. No.: US 2025/0136507 A1
(43) Pub. Date: May 1, 2025

(54) BINDER COMPRISING CARBONATED BIOMASS ASH

(71) Applicant: VICAT, L'Isle-d'Abeau (FR)

(72) Inventors: Laury BARNES-DAVIN, Voiron (FR); Virginie NOWALSKI, Chassignieu (FR)

(73) Assignee: VICAT, L'lsle-d'Abeau (FR)

(21) Appl. No.: 18/835,059

(22) PCT Filed: Feb. 16, 2023
(86) PCT No.: PCT/FR2023/050207

§ 371 Date: Aug. 1, 2024

(30) Foreign Application Priority Data
Feb. 17, 2022 (FR) 22/01385

(51) Int. Cl. C04B 18/06; C04B 7/02; C04B 28/04; C04B 111/00

(52) U.S. Cl. CPC C04B 18/061; C04B 7/02; C04B 28/04; C04B 2111/00017

(57) ABSTRACT

A binder including at least 1% of carbonated biomass ashes and construction material including the cementitious composition.

The subject of the present invention is new binders with a low carbon balance comprising carbonated biomass ashes as well as the construction materials prepared from said binders.

The manufacture of binders, in particular the hydraulic binders, and in particular that of cements, essentially consists in calcining a mixture of carefully selected and dosed raw materials, also called <<raw-mix>>. The cooking of this raw material produces an intermediate product, the clinker, which, when milled with calcium sulfate and possible mineral additions, will produce cement. The type of manufactured cement depends on the nature and proportions of the raw materials as well as the cooking method. There are several types of cements: Portland cements (which represent most of cements produced in the world), aluminous cements (or calcium aluminate), natural quick setting cements, sulpho-aluminous cements, sulfo-belitic cements and other intermediate varieties.

The most widely used cements are the Portland type cements. The Portland cements are obtained from Portland clinker, obtained after clinkering at a temperature in the range of 1450° C. from a raw-mix material rich in calcium carbonate in a furnace. The production of one ton of Portland clinker is accompanied by the emission of significant quantities of CO₂ (about 0.8 to 0.9 tons of CO₂ per ton of cement in the case of a clinker).

Yet, in 2014, the amount of cement sold worldwide was around 4.2 billion tons (source: French Trade Union for the Cement Industry—SFIC). This figure, which is constantly increasing, has more than doubled in 15 years. The cement industry is therefore today looking for a valid alternative to Portland cement, that is to say cements having at least the same strength and quality features as Portland cements, but which, during their production, emit less CO₂.

During the production of clinker, the main constituent of Portland cement, the release of CO₂ is linked to:
up to 40% for heating the cement kiln, in milling and in transport;
up to 60% of so-called chemical CO₂, or of decarbonation CO₂.

The decarbonation is a chemical reaction that takes place when limestone, the main raw material for the manufacture of Portland cement, is heated at high temperatures. The limestone is then transformed into quick lime and CO₂ according to the following chemical reaction:

CaCO₃→CaO+CO₂

The natural carbonation of cement-based materials, particularly concretes, is a potential way to reduce the carbon footprint linked to the manufacturing process and use of cement. However, although concrete prepared from these cements are naturally recarbonated during the life of the structures to the tune of 15% to 20% of the CO₂ emitted during the manufacturing, the carbon balance associated with the production of Portland cement remains positive. It therefore remains necessary to reduce CO₂ emissions during the production of Portland cement and/or to improve end-of-life concrete recovery methods.

To reduce the CO₂ emissions related to the production of Portland cement, several approaches have been considered so far:
adapting or modernizing cement methods in order to maximize the efficiency of heat exchanges;
developing new <<low carbon>> binders such as sulpho-aluminous cements prepared from raw materials less rich in limestone and at a lower cooking temperature, which allows a reduction in CO₂ emissions of about 35%;
or even more (partial) substituting clinker in cements with materials making it possible to limit CO₂ emissions.

Among the above approaches, that of (partial) substitution of clinker in cements has been the subject of numerous developments.

Among the used substitute materials, it can notably cited slag from blast furnaces and fly ashes from coal-fired power stations. However, the closure of coal-fired power stations is causing a shortage of good quality fly ashes. Furthermore, the substitution of clinker with limestone filler (that is to say an inactive material) essentially has a dilution effect and is accompanied by a significant drop in strength, which is problematic.

Carbon capture and storage technologies have also been developed to limit the CO₂ emissions from cement plants or coal-fired power plants. International patent application WO-A-2019/115722 describes a method allowing both the cleaning of CO₂-containing exhaust gases and the manufacture of additional cementitious material. The described method involves using recycled concrete fines comprising the provision of recycled concrete fines with d₉₀≤1000 μm into stocks or a silo as a starting material, rinsing the starting material to provide a carbonaceous material, the removal of the carbonaceous material and the cleaned exhaust gas, and the deagglomeration of the carbonaceous material to form the additional cementitious material, as well as the use of stocks or a silo containing a starting material of recycled concrete fines with d₉₀≤1000 μm for cleaning CO₂-containing exhaust gases and the simultaneous manufacture of an additional cementitious material. However, this method requires drying the carbonated product before it can be used.

At the date of the present invention, it therefore remains necessary to identify new substitute materials making it possible to significantly reduce the CO₂ emissions during the production of cement while maintaining the mechanical properties of the construction materials prepared from these cements, in particular medium and long-term compressive strengths, at levels allowing their use.

The biomass ashes, that is to say the ashes obtained from the combustion of biomass such as wood, so-called annual plants, agricultural residues, paper and wastewater treatment plant sludge (or STEP sludge) are valued through their use in different fields. Thus, it is noted that biomass ashes are used in particular to stabilize foundation soils, for the treatment of liquid effluents or even as a secondary raw material in ceramic products or as a mineral filler in bituminous coatings.

The use of carbonated biomass ashes in the form of monoliths as a substitute for light aggregates was studied by Hills Colin et al. in their publication <<Valorisation of agricultural biomass-ash with CO₂>>, Scientific Reports, vol. 10, no 1, 1 Dec. 2020. The use of such ashes as a cement substitute, or, more generally, as a binder substitute, is never mentioned by the authors. Moreover, the solution presented in this document only makes it possible to reduce the carbon footprint associated with the production of the construction material due to the capture of CO₂ by the aggregate used to prepare it (the production of said aggregates does not produce (or little) CO₂.

The use of biomass ashes as alternatives to coal fly ashes as a substitute material in cementitious compositions was also evaluated. However, several authors, such as Ivana Carević et al., <<Correlation between physical and chemical properties of wood biomass ash and cement composites performances>>, Construction and Building Materials, Vol. 256, 30 Sep. 2020, 119450, have found that the use of these ashes in cements or concretes leads to a loss of workability which makes the implementation of the cement or concrete difficult. The workability can be partially restored by increasing the amount of mixing water, but this increase in the W/C ratio results in a loss of mechanical strength.

This workability issue is also reported in Japanese patent application JP-A-2021-155720. The purpose of this patent application is to provide a method for preparing a construction material capable of capturing/immobilizing the CO₂ quickly. A method for preparing a construction material comprising a step of carbonating an alkaline solid containing calcium then a mixing with a cement is described in particular. It is nevertheless explained that the use of alkaline solids containing calcium in cements is associated with workability problems and that the use of coal ashes (i.e. fly ashes) should be preferred in order to limit this effect.

Yet, it has now been found quite surprisingly that the carbonation of biomass ashes allows their use as a cementitious addition without this reducing the workability of the cement or concrete finally prepared. Furthermore, it has also been observed that carbonated biomass ashes do not behave like simple fillers but contribute to increasing the performance of the binder, which makes it possible to significantly increase the substitution rate of said binder compared to conventional filler, thus making it possible to significantly reduce the carbon footprint of the construction material finally prepared while maintaining mechanical properties, and in particular medium and long-term compressive strengths compatible with the intended uses. The use of carbonated biomass ashes as a cement substitute therefore makes it possible to lower the carbon footprint associated with the production of the construction material not only by the capture of CO₂ by the biomass ashes, but also by the significant reduction in the amount of clinker to be produced to obtain said construction material.

Thus, the subject of the present invention is a binder comprising at least 1% of carbonated biomass ashes.

The use of carbonated biomass ashes in the binders of the invention makes it possible to significantly increase the cement substitution rate compared to conventional fillers, and therefore to significantly lower the carbon footprint of the construction material finally prepared from said binder, and while maintaining a workability and mechanical properties, and in particular medium and long-term compressive strengths compatible with the intended uses.

In the context of the present invention:
the term <<biomass ashes>> means any mainly basic residue from the combustion of various plant, natural and non-fossil organic materials such as wood, so-called annual plants, agricultural residues, paper and wastewater treatment plant sludge (or STEP sludge) containing less than 11% total carbon, less than 4% inorganic carbon, and at least 1% Na₂O equivalent. Preferably, the biomass ashes further contain at least one of the following phases: whitlockite, hydroxyapatite, tremolite and/or tricalcium phosphate;
the term <<carbonated biomass ashes>> means any biomass ashes which, after being brought into contact with a CO₂-enriched gas flow, retains part of it and contains more than 4% of inorganic carbon;
the term <<aluminous cement>> means any cement, amorphous or not, obtained by cooking a mixture of limestone and bauxite and containing at least 5% monocalcium aluminate CA;
the term <<quick natural cement>> means any hydraulic binder with rapid setting and hardening according to standard NF P 15-314:1993 in force on the date of the present invention. Preferably, <<quick natural cement>> designates a cement
prepared from a clinker comprising:
from 0% to 20% of C₃S;
from 40% to 60% of C₂S;
from 7% to 12% C₄AF;
from 2% to 10% C₃A;
from 10% to 15% of CaCO₃ (calcite);
from 10% to 15% of Ca₅(SiO₄)₂CO₃ (spurrite);
from 3% to 10% of sulfate phases: yeelimite C₄A₃$, langbeinite (K₂Mg₂(SO₄)₃, anhydrite (CaSO₄); and
from 10% to 20% lime, periclase, quartz and/or one or more amorphous phases;
the term <<Portland cement>> means any Portland clinker-based cement classified as CEM (I, II, III, IV or V) according to standard NF EN 197-1;
the term <<sulfo-aluminous cement>> means any cement prepared from a sulfo-aluminous clinker containing 5% to 90% of ‘yeelimite’ phase C₄A₃$, a source of sulfate, and, optionally, a limestone addition;
the term <<binder>> means any hydraulic or alkali-activated binder;
the term <<alkali-activated binder>> means any mixture free of aggregates composed of a mineral precursor (generally blast furnace slag or metakaolins) and an alkaline activator. If the precursor is a calcined clay powder, the alkali-activated binder is then called <<geopolymer>>.
the term <<hydraulic binder>> means any binder free of aggregates which reacts with water to form new phases called hydrates, such as for example cement;
the term <<Na₂O equivalent>> or <<Na₂O eq.>> means the alkali content of a cement calculated according to the following formula: % Na₂O eq.=(% Na₂O+0.658% K₂O) soluble in acid;
the term <<loss on ignition>> means the cumulative content of bound water, organic matter, CO₂ of carbonates (limestone fillers and carbonated part of the material) and possible oxidizable elements. The loss on ignition is determined by calcination in air at a temperature of (950+/−25° C.) according to the method described in standard NF EN 196-2 (classification index P 15-472)—Cement testing methods—Part 2: Chemical analysis of cements; and
the term <<construction material>> means mortar or concrete.

In the context of the present invention, the following notations are adopted to designate the mineralogical components of cement:
C represents CaO;
A represents Al₂O₃,
F represents Fe₂O₃;
S represents SiO₂; and
$ represents SO₃.

In the context of the present invention, the <<inorganic carbon rate>> or <<CIT>> corresponds to the amount (% w/w) of inorganic carbon contained in an entity (e.g. carbonated biomass ashes) relative to the total weight of said entity (e.g. said carbonated biomass ashes).

To determine the level of inorganic carbon, different methods can be used, such as for example a previously calibrated Carbon Hydrogen Sulfur (CHS) elemental analyzer. To do this, approximately 250 mg of the product to be analyzed is placed in a nickel boat. This boat is then introduced into a tubular quartz furnace allowing a gradual rise in temperature and stages in temperature in order to separate the different carbon species in a sample. It can thus be determined:
the <<COT>>, namely the amount (% w/w) of total organic carbon of the entity determined by analysis of the signal obtained between 100° C. and 400° C. with a temperature hold at 400° C.;
the <<C>>, namely the amount (% w/w) of elemental carbon of the entity determined by analysis of the signal obtained between 400° C. and 600° C. with a temperature hold at 600° C.; and
the <<CIT>>, namely the amount (% w/w) of total inorganic carbon of the entity determined by analysis of the signal obtained between 600° C. and 1000° C. with a temperature hold at 1000° C.

The total carbon <<CT>> corresponds to the sum of these three values: CT=COT+C+CIT

Finally, in the context of the present invention, the proportions expressed in % correspond to mass percentages relative to the total weight of the considered entity (e.g. clinker or cement).

The subject of the present invention is therefore a binder comprising at least 1% of carbonated biomass ashes. Preferably, the present invention relates to a binder as defined above having the following features, selected alone or in combination:
the binder contains at least 5% of carbonated biomass ashes; preferably the binder contains at least of 6% carbonated biomass ashes; more preferably the binder contains at least of 7% carbonated biomass ashes; more preferably the binder contains at least of 8% carbonated biomass ashes; more preferably the binder contains at least of 9% carbonated biomass ashes; very preferably the binder contains at least 10% of carbonated biomass ashes;
the binder contains up to 45% of carbonated biomass ashes; preferably the binder contains up to 40% of carbonated biomass ashes; very preferably the binder contains up to 35% of carbonated biomass ashes;
the carbonated biomass ashes contain at least 4.5% of inorganic carbon; preferably the carbonated biomass ashes contain at least 5% of inorganic carbon; very preferably, the carbonated biomass ashes contain at least 5.5% of inorganic carbon;
the binder contains from 15% to 99% of hydraulic binder or alkali-activated binder; preferably the binder contains from 30% to 95% of hydraulic binder or alkali-activated binder; more preferably the binder still contains from 50% to 93% of hydraulic binder or alkali-activated binder; very preferably the binder contains from 65% to 90% hydraulic binder or alkali-activated binder;
the binder is a hydraulic binder or an alkali-activated binder; preferably the binder is a hydraulic binder; more preferably the binder is a cement; very preferably the binder is an aluminous cement, a quick natural cement, a Portland cement, a sulpho-aluminous cement or a mixture of at least two of these cements;
the binder contains kalcinite, carbo-hydroxyapatite and/or hydrocalumite; and or
the binder also contains a filler or a cementitious addition according to standard EN 197-1.

The binder according to the present invention can be prepared according to any method known to those skilled in the art. By way of example, the binder according to the present invention can in particular be prepared by simple mixing in a crusher or a mixer of a hydraulic binder or an alkali-activated binder with the carbonated biomass ashes, or even by mixing in a grinder or mixer of clinker, gypsum (and optionally limestone filler or any known additive) and carbonated biomass ashes.

The carbonated biomass ashes can be obtained by any method known to those skilled in the art. By way of example, it can in particular be cited a method for preparing carbonated biomass ashes comprising the following steps:
introducing biomass ashes into a rotary drum, mixer, container or fluidized bed type reactor;
bringing the ashes into contact with a source of CO₂ such as exhaust gas from a cement plant or a thermal power plant; and
recovering the obtained carbonated biomass ashes.

The binder according to the present invention can be used to prepare a construction material. Thus, the present invention also relates to a construction material comprising a binder as defined above.

The present invention can be illustrated in a non-limiting manner by the following examples.

### EXAMPLE 1

### Carbonated Biomass Ashes

Different carbonated biomass ashes are obtained by placing a mixture of approximately 250 g of ashes obtained by combustion of different biomasses and 15% by mass of water ashes in a hermetically sealed bowl which is itself fixed on the base of a heated mixing robot.

The compositions and features of the used biomass ashes (Ashes 1 to 4) before carbonation are reported in Table 1 below, in comparison with the composition and features of fly ashes (non-carbonated) usually used in the cement industry.

TABLE 1
Composition and features of biomass ashes before carbonation

| | | | | | Type C |
|---|---|---|---|---|---|
| Composition | Wood | Wood | Paper | Paper | coal fly |
| (% (w/w))/ | ashes | ashes | Ashes | ashes | ashes |
| Features | (Ashes 1) | (Ashes 2) | (Ashes 3) | (Ashes 4) | (Ref.) |
| CaO | 31 | 21 | 54 | 63 | 18.3 |
| SiO₂ | 4 | 2 | 20 | 10 | 43.5 |
| Al₂O₃ | 1 | 2 | 9 | 67 | 20.4 |
| Fe₂O₃ | — | 1 | 1 | 1 | 5.4 |
| SO₃ | 12 | 14 | 2 | 1 | 1.8 |
| P₂O₅ | 4 | 3 | 1 | — | — |
| Na₂O | 1 | 1 | 1 | 1 | 1.5 |
| K₂O | 25 | 26 | 1 | 1 | — |
| MgO | 5 | 3 | 2 | 2 | 4.3 |
| TiO₂ | — | — | 1 | — | — |
| Loss on | 15 | 20 | 8 | 14 | 0.9 |
| ignition | | | | | |
| CIT | 3.4 | 3.1 | 1.9 | 3.9 | — |

The reactor is equipped with a cup containing water to regulate the relative humidity in the reactor.

The temperature of the bowl is maintained at 55° C. The bowl cover is equipped with 2 orifices which allow the injection of a gas and its evacuation.

The gas is injected for a mixing time of 1 hour and is made up of 100% CO₂.

The biomass ashes thus carbonated have the following features (Table 2), in comparison with non-carbonated biomass ashes.

TABLE 2
Ashes/carbonate ashes

| | | CIT (%) |
|---|---|---|
| Ashes 1 | Before carbonation | 3.4 |
| | Carbonated | 4.8 |
| Ashes 2 | Before carbonation | 3.1 |
| | Carbonated | 8.6 |
| Ashes 3 | Before carbonation | 1.9 |
| | Carbonated | 4.8 |
| Ashes 4 | Before carbonation | 3.9 |
| | Carbonated | 7.8 |

### EXAMPLE 2

### Binders According to the Invention

A reference Portland cement of class CEM I 52.5 R is mixed with different amounts of non-carbonated or carbonated ashes from Example 1.

The compositions of binders 2 to 5 (binders according to the invention) and 6 to 9 (binders prepared from non-carbonated ashes) thus obtained are reported in the following Tables 3.1, 3.2 and 3.3.

TABLE 3.1
Binders 1 to 9

| Binder (% w/w) | 1 (Ref.) | 2 | 3 | 4 | 5 | 6 | 7 | 8 | 9 |
|---|---|---|---|---|---|---|---|---|---|
| CEM I 52.5 | 100 | 75 | 75 | 75 | 75 | 75 | 75 | 75 | 75 |
| Carbonated | 0 | 25 | 0 | 0 | 0 | 0 | 0 | 0 | 0 |
| ashes 1 | | | | | | | | | |
| Carbonated | 0 | 0 | 25 | 0 | 0 | 0 | 0 | 0 | 0 |
| ashes 2 | | | | | | | | | |
| Carbonated | 0 | 0 | 0 | 25 | 0 | 0 | 0 | 0 | 0 |
| ashes 3 | | | | | | | | | |
| Carbonated | 0 | 0 | 0 | 0 | 25 | 0 | 0 | 0 | 0 |
| ashes 4 | | | | | | | | | |
| Non-carbonated | 0 | 0 | 0 | 0 | 0 | 25 | 0 | 0 | 0 |
| ashes 1 | | | | | | | | | |
| Non-carbonated | 0 | 0 | 0 | 0 | 0 | 0 | 25 | 0 | 0 |
| ashes 2 | | | | | | | | | |
| Non-carbonated | 0 | 0 | 0 | 0 | 0 | 0 | 0 | 25 | 0 |
| ashes 3 | | | | | | | | | |
| Non-carbonated | 0 | 0 | 0 | 0 | 0 | 0 | 0 | 0 | 25 |
| ashes 4 | | | | | | | | | |

TABLE 3.2
Binders 1 to 9 (phasic composition)

| Binder (% w/w) | 1 | 2 | 3 | 4 | 5 | 6 | 7 | 8 | 9 |
|---|---|---|---|---|---|---|---|---|---|
| C₃S | 61.2 | 48.6 | 47.3 | 46.5 | 46.8 | 48.6 | 48.1 | 46.7 | 46.8 |
| C₂S Alpha′H | 2.8 | 2.8 | 2.3 | 5.3 | 2.8 | 2.6 | 2.2 | 6.3 | 5.9 |
| C₂S beta | 7.0 | 7 | 6.2 | 7.8 | 7.5 | 6.4 | 6.9 | 8.5 | 7.6 |
| C₃A | 3.3 | 3.3 | 3.1 | 2.9 | 2.9 | 3.1 | 2.5 | 2.9 | 2.9 |
| C₄AF | 12.2 | 9 | 8.3 | 9.3 | 9 | 9.2 | 9.8 | 9.1 | 9 |
| C₁₂A₇ | 0.5 | 0.5 | 0.5 | 0.7 | 0.6 | 1.1 | 0.8 | 0.7 | 1.6 |
| Calcite | — | 5.2 | 6.1 | 12.5 | 19.6 | 2.6 | 4.9 | 3.9 | 8.5 |
| Kalicinite | — | 3.3 | — | — | — | 0 | — | — | — |
| Sylvite | — | — | — | — | — | — | 0.5 | — | — |
| Lime | 0.1 | 0.1 | 0.2 | 0.7 | 0.3 | 0.9 | — | 5.6 | 6.5 |
| Periclase | 0.9 | 0.5 | 1.4 | 0.6 | 0.4 | 1.4 | 0.6 | 0.8 | 0.5 |
| Hydroxyapatite | — | — | — | — | — | 2.1 | 1.7 | — | — |
| Carbo- | — | 2 | 2.7 | — | 0.2 | — | — | — | — |
| hydroxyapatite | | | | | | | | | |
| Hydrocalumite | — | — | — | 0.7 | 0.5 | — | — | — | — |
| Quartz | 0.6 | 0.2 | 0.1 | 1.6 | 0.4 | 0.3 | 0.3 | 1.7 | 0.9 |
| Anhydrite | 0.9 | 1 | 1.1 | 1.3 | 1 | 1.2 | 1.1 | 1.4 | 1.1 |
| Bassanite | 1.8 | 1.6 | 1.3 | 1.5 | 1.5 | 1.8 | 2 | 1.5 | 1.5 |
| Gypsum | 2.3 | 2 | 1.9 | 1.2 | 1.2 | 2.2 | 1.9 | 1.2 | 1.2 |
| Syngenite | 1.7 | 1.3 | 1.5 | — | — | 1.5 | 1.4 | — | — |
| Aphtithalitis | 1.2 | 0.3 | 0.3 | 0.2 | 0.2 | 0.5 | 0.4 | 0.2 | 0.2 |
| Arcanite | 1.0 | 8.9 | 10.8 | 0.3 | 0.3 | 6.9 | 8.9 | 0.3 | 0.3 |
| Ca-Langbeinite | 0.3 | 0.1 | 0.2 | — | — | 0.3 | — | — | — |
| Portlandite | 0.2 | 2.1 | 1.8 | 1.9 | 1.6 | 5 | 4.6 | 1.8 | 1.6 |
| Amorphous | — | 7 | 6.7 | 5.7 | 5.3 | 6.5 | 6.3 | 5.1 | 3.6 |

TABLE 3.3
Binders 1 to 9 (elemental analysis)

| Binder (% p/p) | 1 | 2 | 3 | 4 | 5 | 6 | 7 | 8 | 9 |
|---|---|---|---|---|---|---|---|---|---|
| SiO₂ | 20.3 | 15.9 | 15.6 | 19.8 | 17.6 | 16.1 | 15.8 | 20.1 | 17.8 |
| Al₂O₃ | 4.6 | 3.7 | 3.9 | 5.5 | 4.9 | 3.8 | 4 | 5.8 | 5.3 |
| Fe₂O₃ | 3.3 | 2.5 | 2.7 | 2.7 | 2.6 | 2.6 | 2.7 | 2.7 | 2.6 |
| CaO | 61.6 | 52.4 | 51 | 57.3 | 57.8 | 53.1 | 51.3 | 59.8 | 61.9 |
| MgO | 1.9 | 2.4 | 2.2 | 1.9 | 1.7 | 2.6 | 2.2 | 1.9 | 1.8 |
| SO₃ | 3.6 | 5.2 | 6.4 | 3.2 | 3 | 5.4 | 6.5 | 3.3 | 3 |
| K₂O | 1.0 | 7 | 7.7 | 0.9 | 1 | 7.1 | 8.1 | 0.9 | 0.8 |
| Na₂O | 0.2 | 0.4 | 0.5 | 0.3 | 0.4 | 0.4 | 0.5 | 0.3 | 0.4 |
| SrO | 0.1 | 0.1 | 0.1 | 0.1 | 0.1 | 0.1 | 0.1 | 0.1 | 0.1 |
| TiO₂ | 0.3 | 0.2 | 0.2 | 0.4 | 0.3 | 0.2 | 0.2 | 0.5 | 0.3 |
| P₂O₅ | 0.2 | 0.9 | 1 | 0.4 | 0.2 | 1 | 1 | 0.4 | 0.1 |
| MnO | 0.07 | 0.3 | 0.4 | 0.1 | 0.1 | 0.3 | 0.43 | 0.1 | 0.1 |
| Na2O eq. | — | 5 | 5.5 | 0.9 | 1 | 5.5 | 5.8 | 0.9 | 1 |
| Loss on ignition | 1.86 | 8.6 | 7.6 | 5.3 | 8.4 | 6.1 | 6.7 | 1.9 | 3.6 |
| (950° C.) | | | | | | | | | |

The gain in CO₂ emissions for the binders 2 to 5 compared to the reference binder 1 is reported in the following Table 4.

TABLE 4
CO₂ gain for the binders 2 to 5

| Binder | 2 | 3 | 4 | 5 |
|---|---|---|---|---|
| CO₂ gain compared to the | 213 | 201 | 219 | 226 |
| reference (KgCO₂eq/t) | | | | |

### EXAMPLE 3

### Workability (Spreading)

A spreading measurement was carried out in accordance with standard EN 1015-3 on 3 mortars manufactured according to standard 196-1 by mixing 450 g of binder 1, 4 or 8, 1350 g of sand and 225 g of water.

The results are reported in the following Table 5.

TABLE 5
Spreading measurement for the binders 1, 3 and 8

| | Mortar prepared | Mortar prepared | Mortar prepared |
|---|---|---|---|
| | from binder 1 | from binder 3 | from binder 8 |
| Spread (in mm) | 185 | 142 | 133 |

As these results show, the use of a mixture of cement and non-carbonated ashes leads to a loss of almost 30% in workability. Carbonating the ashes before mixing with the cement makes it possible to limit the loss of rheology and maintain it at an acceptable level for a good implementation.

### EXAMPLE 4

### Mechanical Performances

The compressive strength of the binders obtained in Example 2 was measured on prismatic specimens of standardized mortar (4×4×16 cm3), at different time periods (1, 2, 7 and 28 days) according to standard EN 196-1.

The obtained results are reported in the following Table 6.

TABLE 6
Compressive strength of binders 1 and 4 to 9

| Binder | 1 | 4 | 5 | 6 | 7 | 8 | 9 |
|---|---|---|---|---|---|---|---|
| R_{c} (in MPa) | 29.3 | 17.4 | 18.8 | — | — | — | 3 |
| at 1 day | | | | | | | |
| R_{c} (in MPa) | 41.7 | 30.7 | 35.1 | — | — | 26.1 | 7 |
| at 2 days | | | | | | | |
| R_{c} (in MPa) | 52.9 | 43.7 | 48.1 | 3.2 | 17.8 | 41.4 | 15 |
| at 7 days | | | | | | | |
| R_{c} (in MPa) | 62 | 52.5 | 51 | 3.5 | 25.5 | 43.4 | 21 |
| at 28 days | | | | | | | |

The binders according to the invention (i.e. binders 4 and 5) present acceptable performances with regard to those observed for the reference CEM I at all deadlines. It is thus noted that mechanical performance is maintained in the short, medium and long term at an acceptable level.

On the other hand, there is a sharp reduction in the mechanical performance of binders containing non-carbonated biomass ashes.

### EXAMPLE 5

### Comparative Examples

### 5.1-Coal-Type Fly Ashes-Based Binder

The coal-type fly ashes whose composition is reported in Table 1 are carbonated according to the protocol of Example 1.

The binder 10 is obtained by mixing a reference Portland cement of class CEM I 52.5 R with the carbonated ashes thus obtained in a proportion (% w/w) 75/25.

5.2—Carbonated Binder after Addition of Non-Carbonated Ashes

The binder 11 is obtained by carbonation according to the protocol of Example 1 of a 75/25 mixture (% w/w) of a reference Portland cement of class CEM I 52.5 R with paper ashes no 4 of example 1 (non-carbonated ashes).

### 5.3—Comparative Results

### 5.3.1—Workability (Spreading)

The workability of the binder 11 is evaluated according to the protocol of Example 3.

The mortar prepared from the binder 11 is too dry and therefore does not spread, making its implementation impossible.

### 5.3.2—Compressive Strength

The compressive strength of binders 10 and 11 is evaluated according to the protocol of Example 4.

The obtained results are reported in the following Table 7.

TABLE 7
Compressive strength of binders 10 and 11

| Binder | 10 | 11 |
|---|---|---|
| R_{c} (in MPa) at 2 days | 29.5 | 14 |
| R_{c} (in MPa) at 7 days | 40.6 | 28.8 |
| R_{c} (in MPa) at 28 days | 48.5 | 30.8 |

The compressive strengths of binders prepared from fly ashes from coal combustion are significantly lower than the compressive strengths of binders prepared from carbonated biomass ashes at 2, 7 and 28 days. The obtained results for binder 11 are extremely low (loss of more than 50% of performance compared to the 100% Portland reference) and render this binder unusable.

1. A binder comprising at least 1% of of carbonated biomass ashes.

2. The binder according to claim 1, wherein it contains at least 5% of carbonated biomass ashes.

3. The binder according to claim 2, wherein it contains at least 10% of carbonated biomass ashes.

4. The binder according to claim 1, wherein it contains up to 45% of biomass ashes.

5. The binder according to claim 1, wherein the carbonated biomass ashes contain at least 5% of inorganic carbon.

6. The binder according to claim 1, wherein it contains from 65% to 99% of hydraulic binder or alkali-activated binder.

7. The binder according to claim 1, wherein the binder is a hydraulic binder.

8. The binder according to claim 7, wherein the binder is a cement.

9. The binder according to claim 8, wherein the binder is an aluminous cement, a quick natural cement, a Portland cement, a sulfo-aluminous cement or a mixture of at least two of these cements.

10. The binder according to claim 1, wherein it contains kalcinite, carbo-hydroxyapatite and/or hydrocalumite.

11. A construction material comprising a binder as defined in claim 1.
